(19) United States
(12) Patent Application Publication
(10) Pub. No.: US 2026/0087232 A1
(43) Pub. Date: Mar. 26, 2026

(54) SYSTEMS AND METHODS FOR GENERATING REQUIREMENT COMPLIANT ARTIFACTS USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Shailendra Singh, Thane West (IN); Pushpa Neelakantan, Chennai (IN); Amrut Nayak, Mumbai (IN); Krishna Mamadapur, Pune (IN)

(73) Assignee: BANK OF AMERICA CORPORATION, CHARLOTTE, NC (US)

(21) Appl. No.: 18/895,676

(22) Filed: Sep. 25, 2024

(51) Int. Cl. G06F 40/117; G06F 40/197

(52) U.S. Cl. CPC G06F 40/117; G06F 40/197

(57) ABSTRACT

Systems, computer program products, and methods are described herein for generating requirement compliant artifacts using advanced computational models for data analysis and automated processing. The present disclosure is configured to ingest a document, wherein the document originates from a distributed network; analyze the document, wherein the document is analyzed using a document analyzing engine to understand a context of the document and to generate a schema map of the document; tag the document, wherein tagging the document comprises generating a script configured to generate an alternative interface associated with the document, and wherein tagging the document comprises prioritizing, based on the context of the document, information associated with the document; configure the script based on user data and compliance data; bind the script to a compliant document, wherein the compliant document comprises the document; and deploy the compliant document to a user device.

### TECHNOLOGICAL FIELD

Example embodiments of the present disclosure relate to systems and methods for generating requirement compliant artifacts using advanced computational models for data analysis and automated processing.

### BACKGROUND

There are significant challenges associated with generating requirement compliant artifacts using conventional systems. Applicant has identified a number of deficiencies and problems associated with generating requirement compliant artifacts in a conventional system. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for generating requirement compliant artifacts using advanced computational models for data analysis and automated processing.

Embodiments of the present invention address the above needs and/or achieve other advantages by providing apparatuses (e.g., a system, computer program product, and/or other devices) and methods for generating requirement compliant artifacts using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention may ingest a document, wherein ingesting the document includes feeding the document to an ingestion engine, and where the document originates from a distributed network. Further, in some embodiments, the present invention may analyze the document, wherein the document is analyzed using a document analyzing engine to understand a context of the document and to generate a schema map of the document. In some embodiments, the present invention may tag the document, wherein tagging the document includes generating a script to generate an alternative interface associated with the document, and wherein tagging the document includes prioritizing, based on the context of the document, information associated with the document. In some embodiments, the present invention may configure the script based on user data and compliance data. In some embodiments, the present invention may bind the script to a compliant document, wherein the compliant document includes the document. Further, in some embodiments, the present invention may deploy the compliant document to a user device.

In some embodiments, the document may include an unstructured document, wherein the unstructured document includes at least an element.

In some embodiments, the element may include at least one of a picture, a chart, a graph, or an illustration.

In some embodiments, the user data may include disability information, wherein the disability information includes information relating to a user's disability. In some embodiments, the user data may include device information, wherein the device information includes capabilities of the user device to present the compliant document to the user.

In some embodiments, the present invention may identify the user's disability, wherein a disability identification engine identifies the user's disability via user input or via one or more sensors associated with the user device.

In some embodiments, the compliance data may include policy data, wherein the policy data includes rules associated with an entity. In some embodiments, the compliance data may include regulation data, wherein the regulation data includes regulations associated with a governing entity.

In some embodiments, the present invention may generate a smart contract, wherein the smart contract complies with the compliance data via causing the script to be updated based on new compliance data, and causing the script to be updated based on new user data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating requirement compliant artifacts using advanced computational models for data analysis and automated processing, in accordance with an embodiment of the disclosure;

FIG. 2 illustrates an example embodiment of advanced computational models for data analysis and automated processing, in accordance with an embodiment of the disclosure;

FIG. 3 illustrates a process flow for generating requirement compliant artifacts using advanced computational models for data analysis and automated processing, in accordance with an embodiment of the disclosure;

FIG. 4 illustrates an example embodiment of a system configured to generate requirement compliant artifacts, in accordance with an embodiment of the disclosure; and

FIG. 5 illustrates an example embodiment of a document orchestration engine, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on. ”Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application or system, or part of an application or system that serves as a foundation for a larger piece of software and drives the functionality of the software. In some embodiments, an engine may be self-contained, but externally-controllable via code that encapsulates logic designed to perform or execute a specific type of function. In one aspect, an engine may be underlying source code that establishes file hierarchy, input and output methods, and how a specific part of an application or system interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In some embodiments, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration. ” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In the modern world, artifacts (e.g., documents) are used in almost every aspect to convey information. These documents are typically designed for individuals without disabilities to interact with. In this regard, for individuals with disabilities, the documents are generally inaccessible, or at least very difficult to access. Further, individuals with disabilities, such as vision impairments, have difficulty interacting with the documents. The documents as described herein may include structured or unstructured documents. Structured documents are documents that generally include markups that identify the whole document and specific parts of the document. For example, a structured document may include markup that indicates what the document is referencing, and markup on subsections of the document that indicate where the subsections are, what the subsections are referring to, how the subsections are displayed, and so on. Unstructured documents lack the markup that structured documents have, and do not generally conform to specified structures or formats. In this way, unstructured documents typically require ingesting the document before conclusions can be made about what the document is referencing, how the information is presented, where the information is, and so on.

Currently, convention systems attempting to allow people with disabilities to understand unstructured documents have considerable issues. This is because there is no singular horizontal system which caters to any unstructured document conversion regarding compliance requirements, such as requirements set out by the Americans with Disabilities Act (ADA). Further, no conventional systems provide solutions across distributed document management systems. Distributed document management systems (DMS) may be used to provide accurate and transparent document tracing within a network. For example, documents may be dispersed across the distributed DMS to its nodes. The nodes may provide historical representations and tacking of the documents within the DMS. Upon configuring (e.g., viewing, updating, or modifying) a document, the node associated with the document may update the document based on its recent configurations. The configurations may be logged into the distributed DMS and updated to reflect latest versions of the document. However, conventional systems do not provide effective ways for documents updated to ADA requirements to be properly managed. Therefore, a need exists for generating requirement compliant artifacts (e.g., documents) using advanced computational models for data analysis and automated processing.

What is more, the present disclosure provides a technical solution to a technical problem. As described herein, the technical problem includes issues with conventional solutions to managing and generating documents or artifacts compliant with compliance requirements. The technical solution presented herein allows for autogenerating scripts compliant with compliance requirements. In particular, the system as described herein is an improvement over existing solutions for complying with such compliance requirements, (i) with fewer steps to achieve the solution, thus reducing the amount of computing resources, such as processing resources, storage resources, network resources, and/or the like, that are being used (e.g., by generating script programs and sequencing tags using generative artificial intelligence), (ii) providing a more accurate solution to problem, thus reducing the number of resources required to remedy any errors made due to a less accurate solution (e.g., by contextualizing the document and creating a schema map of the document), (iii) removing manual input and waste from the implementation of the solution, thus improving speed and efficiency of the process and conserving computing resources (e.g., by generating a script configured to generate an alternative interface associated with the document and binding the script to the document), (iv) determining an optimal amount of resources that need to be used to implement the solution, thus reducing network traffic and load on existing computing resources (e.g., determining the capabilities of the device used to present the compliant document to the user). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the system as described herein is a solution to the problem of how conventional systems generate compliant documents. Further, the system may be characterized as identifying a specific improvement in computer capabilities and/or network functionalities in response to the system's integration to existing devices, software, applications, and/or the like. In this way, the system improves the capability of a system to generate compliant documents according to a compliance database, or the like. Further, the system improves the functionality of networks in response to reducing the resources consumed by the system (e.g., network resources, computing resources, memory resources, and/or the like).

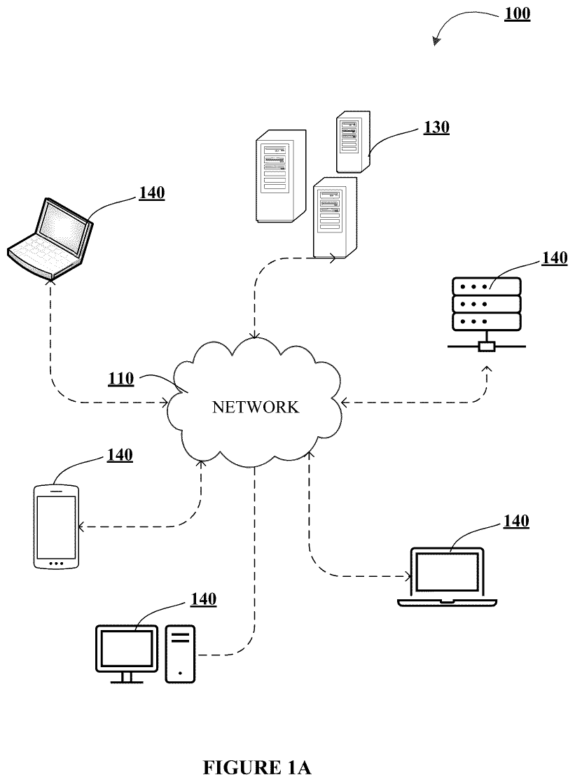

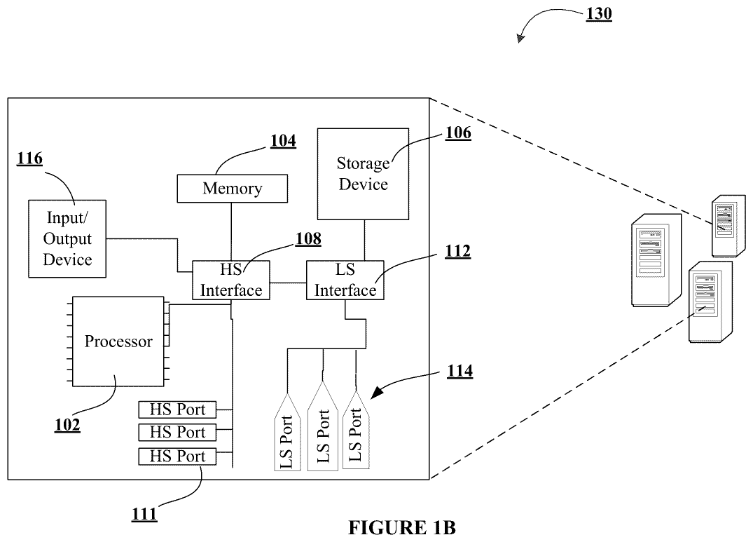

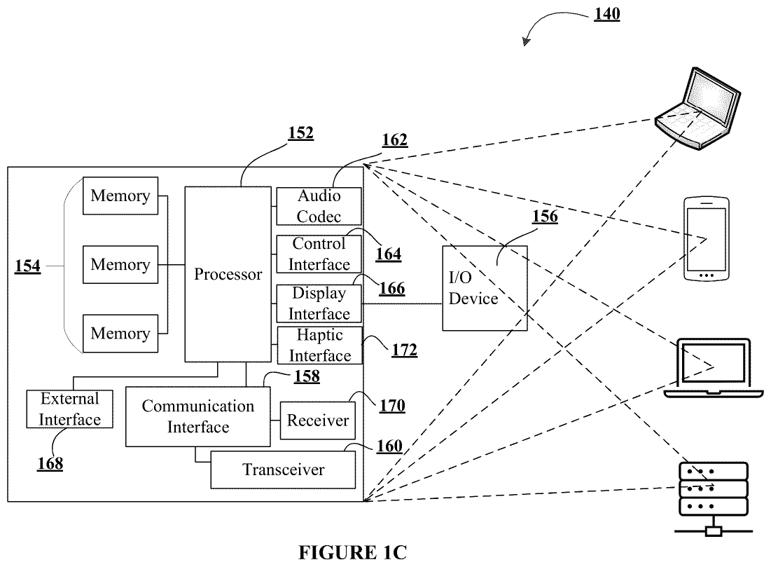

FIGS. 1A-1C illustrate technical components of an exemplary distributed computing environment 100 for generating requirement compliant artifacts using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

The end-point device(s) 140 may also communicate via haptic or tactile feedback, which may use touch sensations to communicate information. A haptic interface 172 may produce the haptic feedback via vibrations, configuring resistance of other interfaces, configuring textures of other interfaces, or the like. The haptic interface 172 may, for instance, generate a vibration of the end-point device(s) 140 based on configurations from one or more applications, components, or systems. In another example, the haptic interface 172 may increase resistance of another device, such as a virtual reality headset, to provide feedback according to an application.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

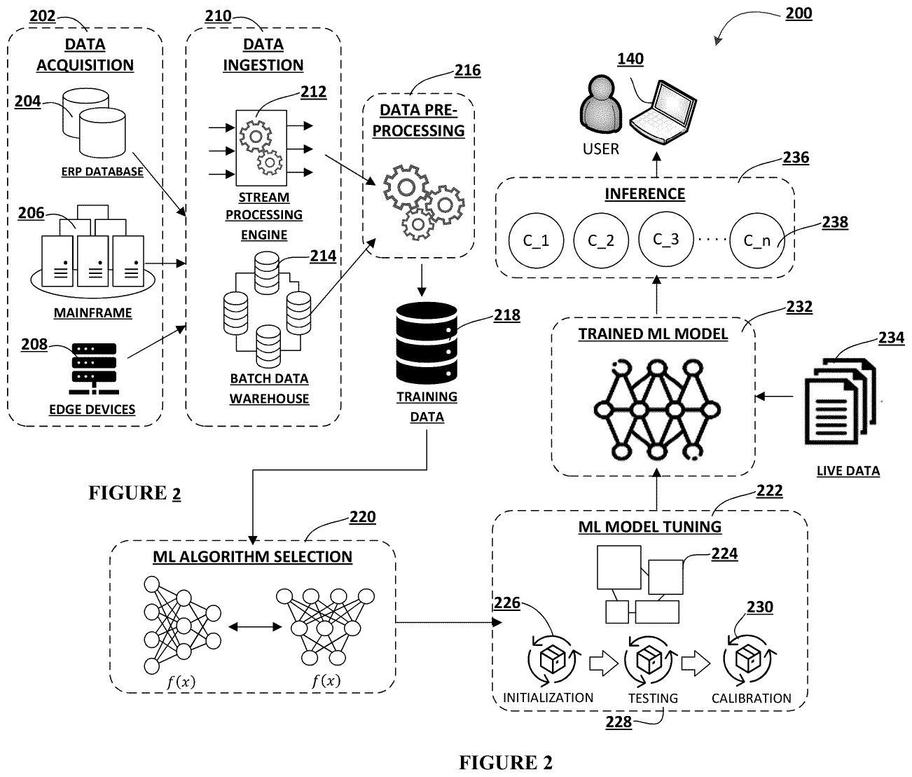

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

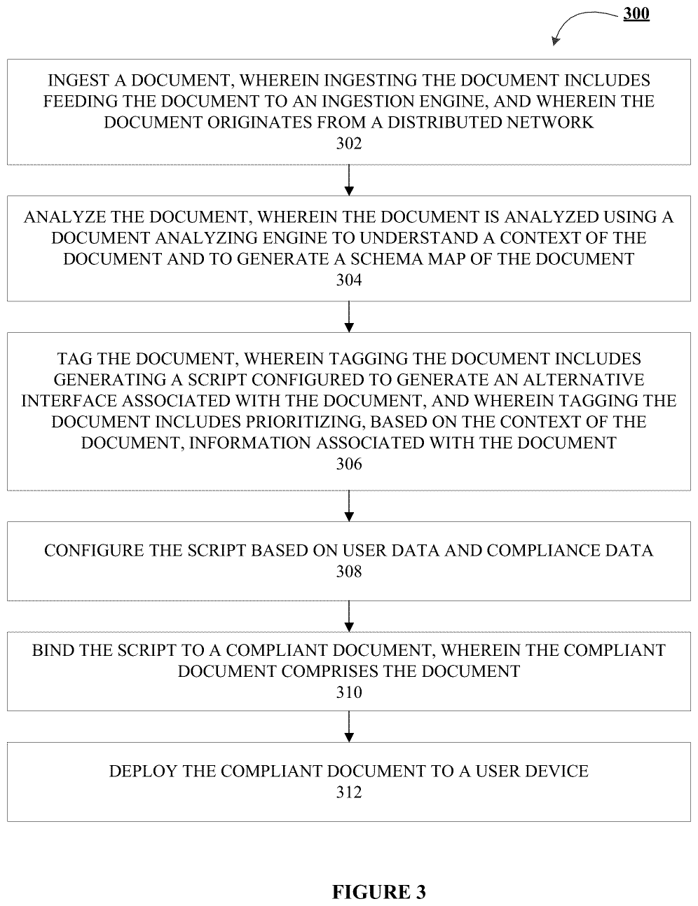

FIG. 3 illustrates a process flow for generating requirement compliant artifacts using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a system (e.g., similar to one or more of the systems described herein with respect to FIGS. 1A-1C) may perform one or more of the steps of process flow 300. For example, the system (e.g., the system 130 described herein with respect to FIGS. 1A-1C) may perform the steps of process flow 300.

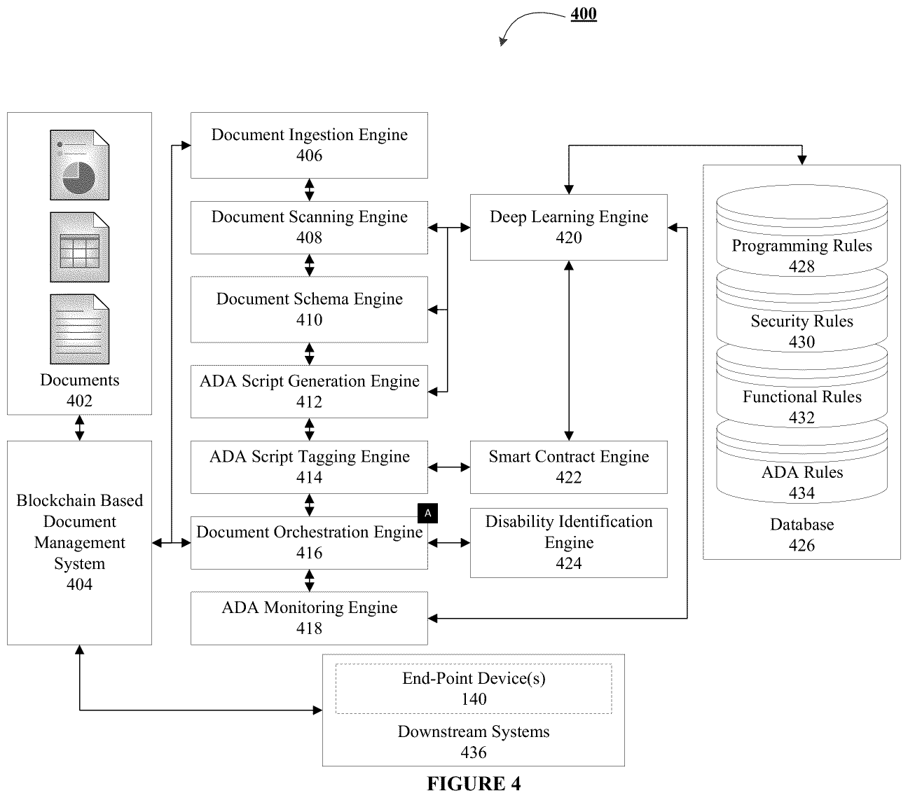

As shown in FIG. 4, the documents 402 may be housed on a distributed network, such as a blockchain based document management system 404. In some embodiments, the document may include an unstructured document, wherein the unstructured document includes at least an element. The documents 402 may include documents that are structured or unstructured. A structured document may be a document that is highly organized and follows predefined formats or structures. Data within a structured document is organized in a way that is easy to search, analyze, and understand by humans, machines, and computers alike. An unstructured document typically lacks predefined structure and organization. In this regard, the unstructured document includes more text that lacks consistent formats, making them more difficult for machines and computers without advanced processing capabilities to understand. For example, an unstructured document that includes free-form text and handwritten notes over the text is more difficult for a computer to process than a highly structured document including a spreadsheet.

In addition, the document 402 may include an element. In some embodiments, the element may include at least one of a picture, a chart, a graph, or an illustration. The element may be a representation of information that is generally easier to convey in the element form rather than a textual form. For example, information associated with a graph is generally easier to convey by viewing the graph, rather than an explanation of the contents of the graph. Further, the element may convey contextual information associated with the document 402.

Further, the distributed network may include a multitude of nodes where the documents 402 are stored. In this regard, the distributed network's nodes may create the document management system (DMS) that is used to store documents across a variety of devices. In some embodiments, the devices used on the blockchain based document management system 404 may include end-point devices 140 (as shown in FIGS. 1A-1C). The distributed network may provide transparency and accuracy when determining versions of the documents 402. For example, a document 402 may be stored on a node within the distributed network and may be accessed by the system (e.g., the system 130 as described herein). In this example, the document 402 may include an original version or an updated version. Importantly, the historical updates of the document 402 may be accessible by the system 130. The system 130 maintaining all versions of the document 402 provides transparency for individuals, such as disabled individuals, who access their documents in order to ensure the document 402 includes correct information. Further, as the system 130 updates the document 402 into, for example, a compliant document, the versions of the document 402 and the compliant document may be stored on the distributed network. In this regard, the historical and current versions of the document 402 and compliant document may be accessible by the user, the entity that hosts the system 130, an authorized individual, or the like.

In some embodiments, and as shown in block 302 of FIG. 3, the system 130 may ingest a document, wherein ingesting the document includes feeding the document to an ingestion engine, and wherein the document originates from a distributed network. The documents 402 may be ingested into the system 130 by way of an ingestion engine, such as the document ingestion engine 406. The document ingestion engine 406 may comply with rules, regulations, and requirements set out by a regulation, governing body, entity, or the like, such as the Americans with Disabilities Act (ADA), the Web Content Accessibility Guidelines (WCAG), or the like. In this regard, the document ingestion engine 406 may include configurations that follow guidelines and rules for how to treat documents 402 as they are received by a system (e.g., the system 130).

In some embodiments, and as shown in block 304 of FIG. 3, the system may analyze the document, wherein the document is analyzed using a document analyzing engine to understand a context of the document and to generate a schema map of the document. The documents 402 may be passed to a document analyzing engine (e.g., a document scanning engine 408, as shown in FIG. 4) which may scan the document to look for certain structures, accessibilities, content, and the like. The document scanning engine 408 may be in communication with a deep learning engine 420 to assist with the scanning or analysis of the document 402. The deep learning engine 420 may include a variety of machine learning techniques and processes, such as those described in FIG. 2, to understand the context of the document 402. Further, the deep learning engine 420 may include neural networks, such as a Generative Adversarial Network (GAN), a Generative Pre-trained Transformer (GPT), Optical Character Recognition (OCR), Long Short-Term Memory (LSTM), or the like. The deep learning engine 420 may analyze the document 402 to understand the document's 402 context. Contextually understanding the document 402 allows the system 130 to determine which sections require tagging, how to prioritize the sections within the document 402, and the like.

In some embodiments, the deep learning engine 420 may communicate with a database 426. The database 426 may include a variety of rules used to analyze the document 402 via the document scanning engine 408 and deep learning engine 420. For example, the database 426 may include programming rules 428, security rules 430, functional rules 432, and ADA rules 434. The rules associated with the database 426 may be updated from time to time by either an entity (e.g., the entity that is hosting the system 130), a third-party entity, a governing body, a regulatory body, a law, a rule, a regulation, or the like. In this regard, the database 426 may be updated continuously and in real-time as to provide the most up to date rules, regulations, and requirements, with which the system 130 may be required to comply. As a specific and non-limiting example, the Department of Justice (DOJ) may update rules associated with the ADA from time to time. The database 426 may be in communication with the updated ADA rules and incorporate them, via either making real-time copies of the updated rules or by incorporating the updates directly from the updated ADA, into the ADA rules 434. In this regard, once the DOJ updates the ADA rules, the ADA rules 434 in the database 426 may reflect the changes for use by the deep learning engine 420, the document scanning engine 408, or any component of the system 130.

In some embodiments, an ADA monitoring engine 418 may monitor the rule and regulation changes set forth by entities that control, own, or update the rules in the database 426. In this regard, the ADA monitoring engine 418 may analyze the rules in the database 426 to ensure they are up to date and communicate changes to the deep learning engine 420, document orchestration engine 416, or the like.

In some embodiments, and as shown in block 306 of FIG. 3, the system may tag the document, wherein tagging the document includes generating a script configured to generate an alternative interface associated with the document, and wherein tagging the document includes prioritizing, based on the context of the document, information associated with the document. The alternative interface may include an interface suited to the user for the user to understand the document 402. In this regard, the alternative interface may change from user to user based on the user's disability. By way of non-limiting examples, the alternative interface may include creating audio that reads aloud the document, enlarging the document, creating haptic interfaces that assist the user in navigating the document, or the like. Further, the alternative interface may be used by the system to present (e.g., read-aloud, enlarge, etc.) the document 402 to the user based on the user's disability.

Further, as shown in FIG. 4, the document schema engine 410 may be used to tag the document 402 after the document scanning engine 408 has analyzed the document 402 for context. Similarly, the deep learning engine 420 may assist, or be a part of, the document schema engine 410 during tagging of the document 402. Further, the document schema engine 410 may use the rules associated with the database 426 during tagging of the document 402.

In some embodiments, tagging the document 402 may include, based on the context provided by the document scanning engine 408, sequencing and prioritizing the information associated with the document 402. In this regard, the tags created for the document 402 may indicate which sections of the document 402 are more important, should be presented to the user first, how the information should be presented, and so on. For example, if a document 402 includes a title of the document as well as a graph, the tagging may indicate the title represents a short description of the document while the graph contains more substantive information of the document. In this example, the graph may be tagged in multiple ways to indicate an X-axis, a Y-axis, and the content of the graph. Further, the tagging may indicate which information of the graph should be presented to the user initially for the user to have an understanding of what information will follow. Next, the tagging may indicate how the system 130 should present the information to the user (e.g., whether it should be read aloud, whether it should be enlarged, etc.).

In some embodiments, the document ingestion engine 406, the document scanning engine 408, and the document schema engine 410 may have pre-processed the document 402 prior to the user causing the document or compliant document to be presented. In this regard, the document 402 may already have been scanned, analyzed, and tagged in a way that conserves resources (e.g., time resources, computing resources, networking resources) prior to the document 402 needing to be presented to the user. For example, the system 130 may pre-process documents 402 stored in the blockchain based DMS 404 once they are uploaded to the blockchain based DMS 404. In this regard, the system 130 may only need to perform user-specific operations of the document 402 upon user request.

In some embodiments, an ADA script generation engine 412 may generate scripts for the document 402 that incorporate the tags generated by the document schema engine 410. The scripts created may provide the system 130 with configurations of the document 402. Further, the ADA script generation engine 412 may be in communication with the deep learning engine 420. The scripts may link each section of the document 402 sequentially, based on the document's 402 context, based on the sequence to be presented to the user, and the like. In this regard, the scripts, via the context of the document, may control how the document 402 is presented to the user.

In some embodiments, and as shown in block 308 of FIG. 3, the system 130 may configured the script based on user data and compliance data. In some embodiments, the compliance data may include policy data, wherein the policy data includes rules associated with an entity. For example, as shown in FIG. 4, the policy data may include rules associated with the database 426, such as the programming rules 428, security rules 430, functional rules 432, and the like. These rules may include an entity's operational rules when configuring documents 402. The rules may be used to ensure internal compliance with an entity's rules and regulations.

Further, in some embodiments, the compliance data may include regulation data, wherein the regulation data includes regulations associated with a governing entity. In some embodiments, the compliance data may include the rules associated with the database 426, as shown in FIG. 4. In some embodiments, for example, an ADA script tagging engine 414 may further tag the document, based on specific ADA rules 434, as governed by the DOJ. The ADA script tagging engine 414 may configure or reconfigure the document 402 via updating the scripts to incorporate ADA rules 434. For example, the ADA script tagging engine 414 may adjust the document's 402 contrast according to the ADA rules 434 to ensure enough color contrast between the text and the background for users with visual impairments. In this regard, the ADA script tagging engine 414 may analyze the document 402 and update the associated scripts to ensure compliance with the ADA.

Further, in some embodiments, the ADA script tagging engine 414 may be in communication with a smart contract engine 422. The smart contract engine 422 may incorporate the scripts and generate a smart contract that executes upon presenting the document 402 to the user. The smart contract may be used to self-execute with terms directly written into the smart contract. The terms of the smart contract may include the tags and scripts generated from the engines (e.g., document schema engine 410, ADA script generation engine 412, and the like) as well as rules from the database 426. In this regard, the smart contract may include the tags, schema map, and scripts that configure the user device to present the document in a way that complies with rules associated with the database 426.

In some embodiments, the user data may include data associated with the user. In some embodiments, the user data includes disability information, wherein the disability information includes information relating to a user's disability. In some embodiments, the system 130 may identify the user's disability, wherein a disability identification engine identifies the user's disability via user input or via one or more sensors associated with the user device. Further, in some embodiments, the user data may include device information, wherein the device information includes capabilities of the user device used to present a compliant document to the user.

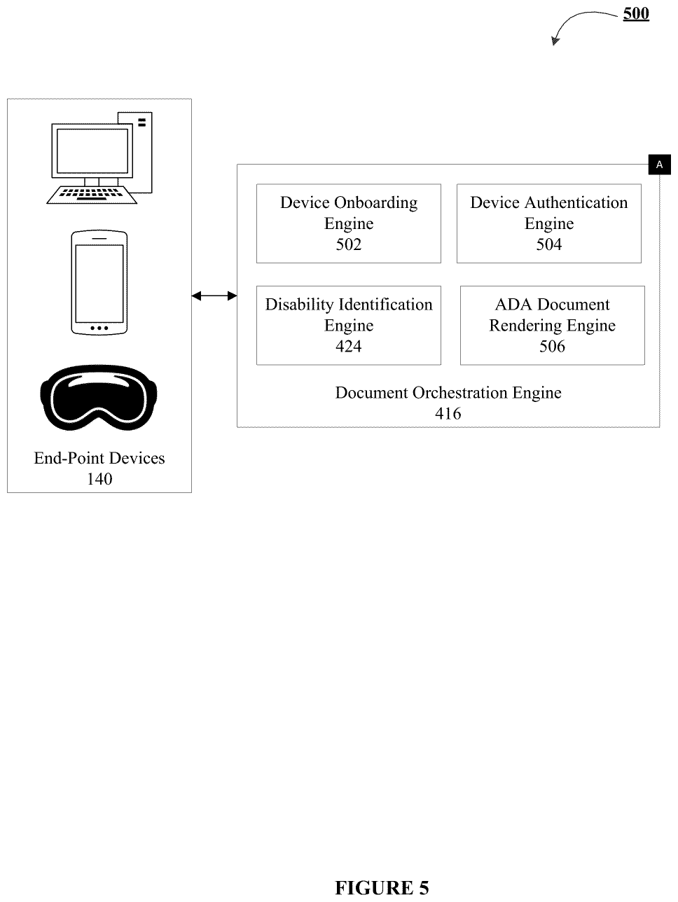

The user data may include a user's disability, impairment, limitation, or the like. The disability identification engine 424, as shown in FIGS. 4 and 5, may determine a user's disability. In some embodiments, the disability identification engine 424 may receive input from a user, wherein the user tells the disability identification engine 424 the user's disability. For example, the user may input that the user has a visual impairment and may also input the extent of the visual impairment. The disability identification engine 424 may analyze the disability information and determine how to present the document 402 to the user. For instance, in the previous example, the user's visual impairment may cause the disability identification engine 424 to either determine that the document 402 should be enlarged when presenting it to the user or that the document 402 should be read aloud when presenting it to the user.

Further, in some embodiments, the disability identification engine 424 may use one or more sensors of the user device to determine the user's disability. In some embodiments, the user device may include an end-point device 140 as described in FIGS. 1A-1C. The sensors associated with the user device may test the user, via the disability identification engine 424, to determine the user's disability and severity of the disability. For example, the disability identification engine 424 may cause a multitude of shades of color that the user needs to rank in ascending order (e.g., from lightest to darkest). Based on the results of the test, the disability identification engine 424 may determine a visual impairment of the user and update the document orchestration engine 416 to present the document 402 to the user in a manner that the user can understand.

In some embodiments, and as shown in block 310 of FIG. 3, the system 130 may bind the script to a compliant document, wherein the compliant document includes the document. In some embodiments, the script may be bound to the compliant document using the smart contract. In some embodiments, binding the script to the compliant document may include configuring the code associated with the document to include the schema map, script, and tags to the document. In some embodiments, binding the script to the compliant document may include generating a new document that includes the schema map, script, and tags, in order to create the compliant document.

The smart contract's self-execution features may be used to automatically execute the script when presenting the document 402 to the user. For example, when the document or compliant document is presented to the user, the smart contract may automatically execute the scripts and tags built by the system 130.

In some embodiments, and as shown in block 312 of FIG. 3, the system 130 may deploy the compliant document to a user device. In some embodiments, and as shown in FIG. 4, the compliant document may be transferred to a downstream system 436 for presentation or deployment to the user. In some embodiments, the downstream systems 436 may include an end-point device 140 as described in FIGS. 1A-1C. Further, the compliant document may be presented to the user in a way that includes using the capabilities of the user device (e.g., downstream system 436 or end-point device 140). For example, as shown in FIG. 5, the end-point device 140 may include a virtual reality (VR) headset. In this example, the compliant document may be presented, via the document orchestration engine 416, on the VR headset and use the functions and features of the VR headset.

Further, the document orchestration engine 416 may include a device onboarding engine 502. The device onboarding engine 502 may determine the capabilities of the user device used to present the document 402 to the user. For example, and as shown in FIG. 5, the end-point device 140 (e.g., user device) may include a variety of devices, such as a personal computer, a mobile phone, virtual reality (VR) headsets, augmented reality (AR) headsets, and the like. Further, the capabilities of the user device may include audio feedback, visual feedback, haptic feedback, and the like. In this regard, when the system 130 presents a document 402 to the user via the user device, the user may receive an audio message, an enlarged visual representation of the document 402, haptic feedback that provides information associated with the document 402, or the like.

In some embodiments, the document orchestration engine 416 may also include a device authentication engine 504. The device authentication engine 504 may authenticate the device (e.g., the user device, the end-point device 140, the downstream device 436, or the like) used to present the compliant document to the user. The device authentication engine 504 may include security features and the like that authorize, authenticate, and verify that the user is using the user device. Further, the device authentication engine 504 may store the capabilities of the user device in order to efficiently create the compliant document. In this regard, the system 130 may know, via the device authentication engine 504, the user device capabilities and create the associated tags, scripts, and schema maps as the document 402 is loaded to the distributed network.

In some embodiments, an ADA document rendering engine 506 may be used by the document orchestration engine 416 to render some or all of the compliant document on the end-point device 140. In this regard, the rendering engine 506 may use the schema, script, and tags to create a model of the compliant document that may be used by the end-point device 140 for presentation to the user. For example, the compliant document may include an interactive portion that may be rendered by the rendering engine 506 and presented via the end-point device 140.

In some embodiments, the system 130 may generate a smart contract, wherein the smart contract complies with the compliance data via causing the script to be updated based on new compliance data. Further, in some embodiments, the smart contract may comply with the compliance data via causing the script to be updated based on new user data. The new user data may include updates to the user's disability, updates to the user device data, or the like. In this regard, as the system 130 receives new information the smart contract may update how it presents the document, compliant document, or the like to the user. For example, updated regulations (e.g., ADA rules 434) may include generating a new smart contract that causes the generation of new schema maps, new scripts, new tags, and new presentation configurations. In this way, the system 130 may be continuously monitoring and updating how rules in the database 426 and how a user's disability may alter the presentation of a compliant document to the user.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating requirement compliant artifacts using advanced computational models for data analysis and automated processing, the system comprising:
a processing device;
a non-transitory storage device containing instructions when executed by the processing device, causes the processing device to perform the steps of:
ingest a document, wherein ingesting the document comprises feeding the document to an ingestion engine, and wherein the document originates from a distributed network;
analyze the document, wherein the document is analyzed using a document analyzing engine to understand a context of the document and to generate a schema map of the document;
tag the document, wherein tagging the document comprises generating a script configured to generate an alternative interface associated with the document, and wherein tagging the document comprises prioritizing, based on the context of the document, information associated with the document;
configure the script based on user data and compliance data;
bind the script to a compliant document, wherein the compliant document comprises the document; and
deploy the compliant document to a user device.

2. The system of claim 1, wherein the document comprises an unstructured document, and wherein the unstructured document comprises at least an element.

3. The system of claim 2, wherein the element comprises at least one of:
a picture,
a chart,
a graph, or
an illustration.

4. The system of claim 1, wherein the user data comprises:
disability information, wherein the disability information comprises information relating to a user's disability; and
device information, wherein the device information comprises capabilities of the user device used to present the compliant document to the user.

5. The system of claim 4, wherein executing the instructions further causes the processing device to identify the user's disability, wherein a disability identification engine identifies the user's disability via user input or via one or more sensors associated with the user device.

6. The system of claim 1, wherein the compliance data comprises:
policy data, wherein the policy data comprises rules associated with an entity; and
regulation data, wherein the regulation data comprises regulations associated with a governing entity.

7. The system of claim 1, wherein executing the instructions further causes the processing device to generate a smart contract, wherein the smart contract complies with the compliance data via:
causing the script to be updated based on new compliance data; and
causing the script to be updated based on new user data.

8. A computer program product for generating requirement compliant artifacts using advanced computational models for data analysis and automated processing, the computer program product comprising a non-transitory computer-readable medium comprising code causing an apparatus to:
ingest a document, wherein ingesting the document comprises feeding the document to an ingestion engine, and wherein the document originates from a distributed network;
analyze the document, wherein the document is analyzed using a document analyzing engine to understand a context of the document and to generate a schema map of the document;
tag the document, wherein tagging the document comprises generating a script configured to generate an alternative interface associated with the document, and wherein tagging the document comprises prioritizing, based on the context of the document, information associated with the document;
configure the script based on user data and compliance data;
bind the script to a compliant document, wherein the compliant document comprises the document; and
deploy the compliant document to a user device.

9. The computer program product of claim 8, wherein the document comprises an unstructured document, and wherein the unstructured document comprises at least an element.

10. The computer program product of claim 9, wherein the element comprises at least one of:
a picture,
a chart,
a graph, or
an illustration.

11. The computer program product of claim 8, wherein the user data comprises:
disability information, wherein the disability information comprises information relating to a user's disability; and
device information, wherein the device information comprises capabilities of the user device used to present the compliant document to the user.

12. The computer program product of claim 11, wherein the code further causes the apparatus to identify the user's disability, wherein a disability identification engine identifies the user's disability via user input or via one or more sensors associated with the user device.

13. The computer program product of claim 8, wherein the compliance data comprises:
policy data, wherein the policy data comprises rules associated with an entity; and
regulation data, wherein the regulation data comprises regulations associated with a governing entity.

14. The computer program product of claim 8, wherein the code further causes the apparatus to generate a smart contract, wherein the smart contract complies with the compliance data via:
causing the script to be updated based on new compliance data; and
causing the script to be updated based on new user data.

15. A method for generating requirement compliant artifacts using advanced computational models for data analysis and automated processing, the method comprising:
ingesting a document, wherein ingesting the document comprises feeding the document to an ingestion engine, and wherein the document originates from a distributed network;
analyzing the document, wherein the document is analyzed using a document analyzing engine to understand a context of the document and to generate a schema map of the document;
tagging the document, wherein tagging the document comprises generating a script configured to generate an alternative interface associated with the document, and wherein tagging the document comprises prioritizing, based on the context of the document, information associated with the document;
configuring the script based on user data and compliance data;
binding the script to a compliant document, wherein the compliant document comprises the document; and
deploying the compliant document to a user device.

16. The method of claim 15, wherein the document comprises an unstructured document, and wherein the unstructured document comprises at least an element.

17. The method of claim 16, wherein the element comprises at least one of:
a picture,
a chart,
a graph, or
an illustration.

18. The method of claim 15, wherein the user data comprises:
disability information, wherein the disability information comprises information relating to a user's disability; and
device information, wherein the device information comprises capabilities of the user device used to present the compliant document to the user.

19. The method of claim 18, wherein the method further comprises identifying the user's disability, wherein a disability identification engine identifies the user's disability via user input or via one or more sensors associated with the user device.

20. The method of claim 15, wherein the compliance data comprises:
policy data, wherein the policy data comprises rules associated with an entity; and
regulation data, wherein the regulation data comprises regulations associated with a governing entity.
